(19) United States
(12) Patent Application Publication
(10) Pub. No.: US 2017/0161946 A1
(43) Pub. Date: Jun. 8, 2017

(54) STOCHASTIC MAP GENERATION AND BAYESIAN UPDATE BASED ON STEREO VISION

(71) Applicant: QUALCOMM Incorporated, San Diego, CA (US)

(72) Inventors: Aliakbar AGHAMOHAMMADI, San Diego, CA (US); Saurav AGARWAL, Bryan, TX (US); Kiran SOMASUNDARAM, San Diego, CA (US); Shayegan OMIDSHAFIEI, Boston, MA (US); Christopher LOTT, San Diego, CA (US); Bardia Fallah BEHABADI, La Jolla, CA (US); Sarah Paige GIBSON, Del Mar, CA (US); Casimir Matthew WIERZYNSKI, La Jolla, CA (US); Gerhard REITMAYR, Vienna (AT); Serafin DIAZ, San Diego, CA (US)

(21) Appl. No.: 15/192,944

(22) Filed: Jun. 24, 2016

Related U.S. Application Data
(60) Provisional application No. 62/262,831, filed on Dec. 3, 2015.

(51) Int. Cl. G06T 17/05; G06F 17/18; B25J 9/16; G06N 7/00; G06N 99/00

(52) U.S. Cl. CPC G06T 17/05; G06N 7/005; G06N 99/005; B25J 9/1697; G06F 17/18; Y10S 901/47

(57) ABSTRACT

A method for generating a map includes determining an occupancy level of each of multiple voxels. The method also includes determining a probability distribution function (PDF) of the occupancy level of each voxel. The method further includes performing an incremental Bayesian update on the PDF to generate the map based on a measurement performed after determining the PDF.

### CROSS REFERENCE TO RELATED APPLICATION

This application claims the benefit under 35 U.S.C. §119(e) to U.S. Provisional Patent Application No. 62/262,831, entitled “STOCHASTIC MAP GENERATION AND BAYESIAN UPDATE BASED ON STEREO VISION,” filed on Dec. 3, 2015, the disclosure of which is expressly incorporated herein by reference in its entirety.

### BACKGROUND

Field

Certain aspects of the present disclosure generally relate to machine learning and, more particularly, to improving systems and methods of maintaining a probability distribution function (PDF) over a map.

Background

In some cases, it is desirable to determine a position of an autonomous vehicle, such as a robot, within a given area. In other cases, given the position of the robot, it is desirable to generate a map of the robot's surroundings. Maps may be generated via an incremental approach or a batch approach.

A map generated via the batch approach may be generated at once after multiple sensor measurements have been gathered throughout an environment to be mapped. That is, in the batch approach, all of the data of an environment to be mapped is gathered before calculating the map. Still, in some cases, a robot may not be able to gather all of the data in an environment prior to calculating the map.

Thus, in some cases, an incremental approach is specified for generating a map. A map generated via the incremental approach may be calculated based on initial data collected from the vicinity of the robot and updated with each new sensor measurement. Each new sensor measurement may be based on the robot changing its location, measuring a different area from the same location, or performing the same measurement for redundancy. For the incremental approach, the sensor measurements are independent from each other. Therefore, the robot may use assumptions when calculating the map. Thus, there may be some uncertainty when calculating an incremental map.

### SUMMARY

In one aspect of the present disclosure, a method for generating a map is disclosed. The method includes determining an occupancy level of each voxel. The method also includes determining a probability distribution function (PDF) of the occupancy level of each voxel. The method further includes performing an incremental Bayesian update on the PDF to generate the map based on a measurement performed after determining the PDF.

Another aspect of the present disclosure is directed to an apparatus including means for determining an occupancy level of each of multiple voxels. The apparatus also includes means for determining a PDF of the occupancy level of each voxel. The apparatus further includes means for performing an incremental Bayesian update on the PDF to generate the map based on a measurement performed after determining the PDF.

In another aspect of the present disclosure, a non-transitory computer-readable medium with non-transitory program code recorded thereon is disclosed. The program code for generating a map is executed by a processor and includes program code to determine an occupancy level of each voxel. The program code also includes program code to determine a PDF of the occupancy level of each voxel. The program code further includes program code to perform an incremental Bayesian update on the PDF to generate the map based on a measurement performed after determining the PDF.

Another aspect of the present disclosure is directed to an apparatus for generating a map having a memory unit and one or more processors coupled to the memory unit. The processor(s) is configured to determine an occupancy level of each of multiple of voxels. The processor(s) is also configured to determine a PDF of the occupancy level of each voxel. The processor(s) is further configured to perform an incremental Bayesian update on the PDF to generate the map based on a measurement performed after determining the PDF.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of motion planning with a system-on-a-chip (SOC), including a general-purpose processor in accordance with certain aspects of the present disclosure.

FIG. 2 illustrates an example implementation of a system in accordance with certain aspects of the present disclosure.

FIGS. 3A, 3B, and 3C illustrate examples of a robot performing measurements according to aspects of the present disclosure.

FIG. 4 illustrates an example of an environment to be mapped according to aspects of the present disclosure.

FIGS. 5, 6A, and 6B illustrate examples of performing measurements according to aspects of the present disclosure.

FIG. 7 illustrates a flow diagram for a method of maintaining a probability distribution function over a map according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

For autonomous systems, such as robots, it is desirable to construct an accurate map of the robot's surroundings. The map may be generated via a sensor, such as a stereo vision sensor. Furthermore, when constructing maps for large environments, voxel sizes are increased to keep the computation tractable.

In one configuration, to determine a map, the map may be partitioned into voxels (e.g., cells). Each voxel may have a state of being occupied (e.g., full), partially occupied, or empty. When generating a map using the incremental approach (e.g., incremental data), conventional techniques may calculate inconsistent maps, may not account for the uncertainty in a determined occupancy level of a voxel, and/or may not determine the occupancy level (e.g., full, partially full, or empty) of voxels. For example, in conventional systems, when calculating a map using the incremental approach, a voxel is either zero (e.g., empty) or one (e.g., full). Thus, conventional systems do not consider the occupancy level of a voxel when calculating a map. In the present application, occupancy level may refer to the ratio of an occupancy over a space. Furthermore, occupancy level may also be referred to as occupancy and/or density.

Aspects of the present disclosure are directed to generating consistent incremental maps that are based on voxels. Furthermore, aspects of the present disclosure determine the occupancy level of a voxel and also determine a probability distribution function (PDF) of an occupancy level given data observed by an autonomous device, such as a robot.

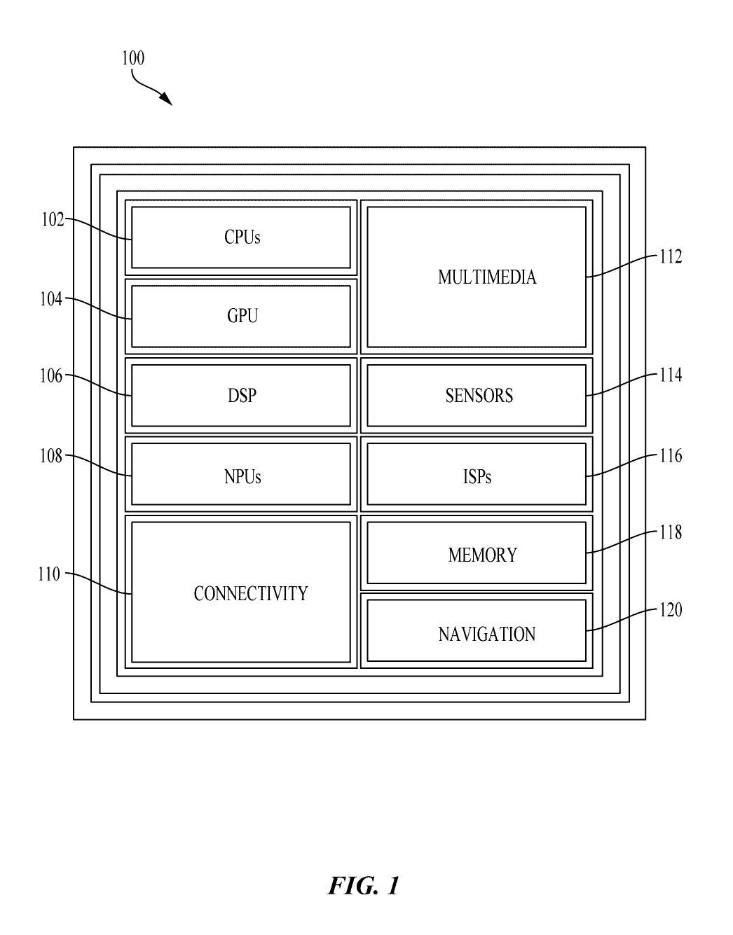

FIG. 1 illustrates an example implementation 100 of the aforementioned maintaining a PDF of a cell using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation 120, which may include a global positioning system.

The SOC may be based on an ARM instruction set. In an aspect of the present disclosure, the instructions loaded into the general-purpose processor 102 may comprise code for determining an occupancy level of each voxel of a plurality of voxels. The general-purpose processor 102 may also comprise code for determining a probability distribution function (PDF). Furthermore, the general-purpose processor 102 may further comprise code for performing an incremental Bayesian update on the PDF to generate the map based on a measurement performed after determining the PDF.

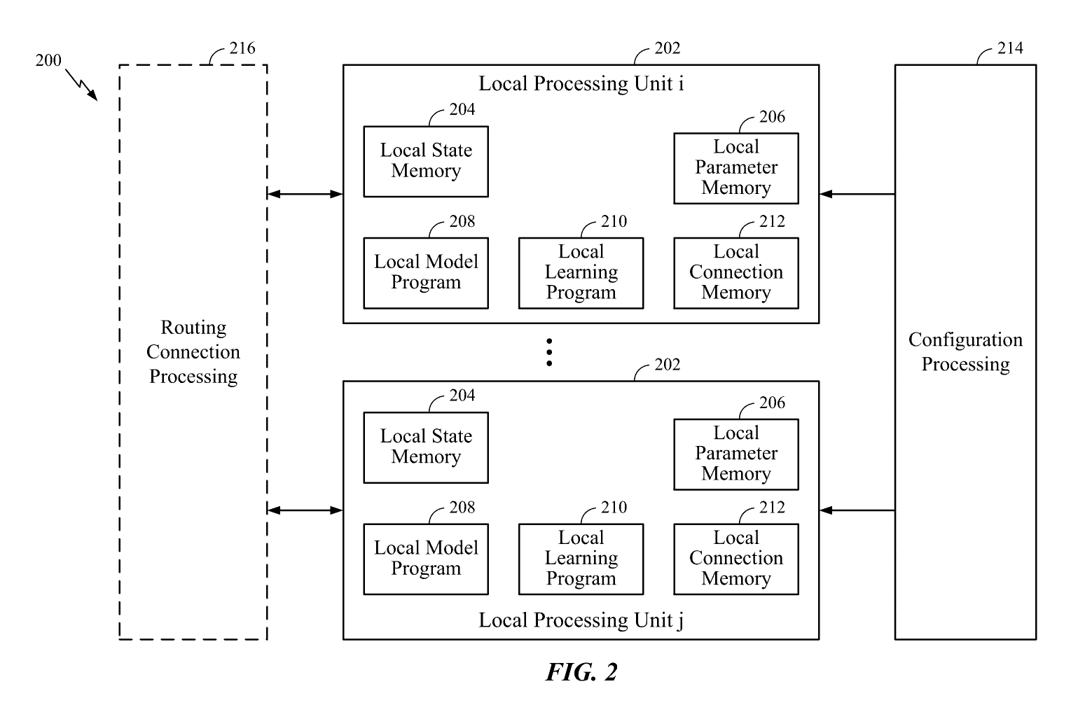

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

In one configuration, a map generating model is configured for determining an occupancy level of each voxel of a plurality of voxels, determining a PDF of the occupancy level, and performing an incremental Bayesian update on the PDF to generate the map based on a measurement performed after determining the PDF. The model includes a determining means and/or a performing means. In one aspect, the determining means and/or the performing means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

### Stochastic Map Generation and Bayesian Update Based on Stereo Vision

As previously discussed, aspects of the present disclosure are directed to determining an occupancy level of each voxel and determining a confidence level of a determined occupancy level. The confidence level may be referred to as a probability distribution function (PDF) of a voxel given data observed by a device, such as a robot (e.g., autonomous device). A confidence level of a map may be based on the confidence level of each of the voxels in the map.

In one configuration, a mapping module is specified for a device, such as a robot. The mapping module may be a digital signal processor (DSP), app-processor, graphics processing unit (GPU), and/or another module. The mapping module may be specified to improve the accuracy of maps generated using incremental data. Furthermore, the mapping module may process the occupancy level of voxels (e.g., enable large voxels and reduce computational complexity), and/or incorporate a sensor model, such as a stochastic sensor model, in map construction. Additionally, the mapping module may process the occupancy levels of voxels in a map and determine the confidence level of the determined occupancy. Finally, the mapping module may be used for improving planning under uncertainty. Aspects of the present disclosure are directed to generating a map for a robot. Still, the maps are not limited to being generated for a robot and are contemplated for any type of device, such as, for example a car, airplane, boat, and/or human. Furthermore, in one configuration, the device is autonomous.

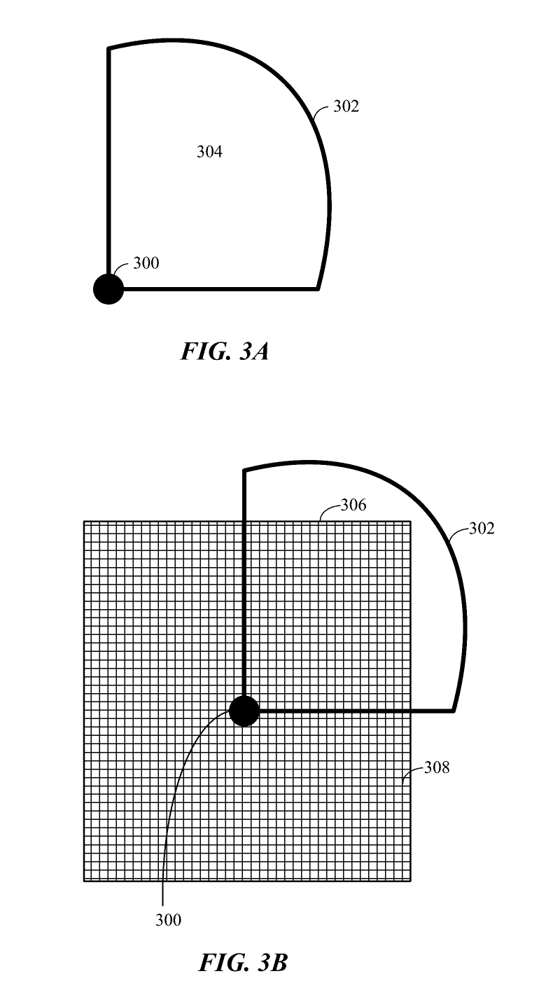

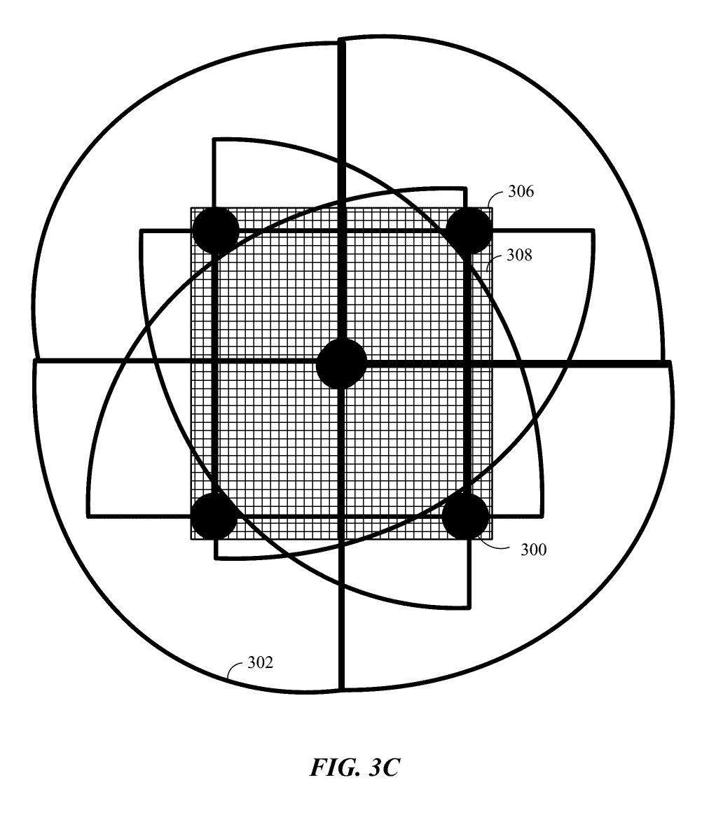

FIGS. 3A, 3B, and 3C illustrate examples of a robot performing measurements according to aspects of the present disclosure. FIG. 3A illustrates an example of a robot 300 performing measurements via one or more sensors (not shown) of the robot 300. Measurements may refer to a measurement obtained based on whether a ray is intercepted by a voxel. Of course, aspects of the present disclosure are not limited to measurement rays and are also contemplated for other types of measurements. As shown in FIG. 3A, the sensor of the robot 300 may have a measurement cone 302 such that the sensor receives measurements from an area 304 within the cone 302.

As shown in FIG. 3B, according to an aspect of the present disclosure, the robot 300 may be placed in an environment to be mapped 306. The environment to be mapped 306 may include multiple voxels 308. As shown in FIG. 3B, based on the measurements by the sensor, the sensor may determine an occupancy level of each voxel 308 within the measurement cone 302. It should be noted that the voxels 308 of FIG. 3B are for illustrative purposes, the voxels of the present disclosure are not limited to the size or number of voxels shown in FIG. 3B.

As shown in FIG. 3C, according to an aspect of the present disclosure, the robot 300 may perform measurements at different locations. For an incremental approach, the map is generated based on measurements obtained at a first location and the generated map is updated as the robot moves to different locations in the environment to be mapped 306. The measurements at different locations are performed at different times (e.g., different time-steps). For example, a robot 300 may perform a first measurement at a first location at a first time and a second measurement at a second location at a second time.

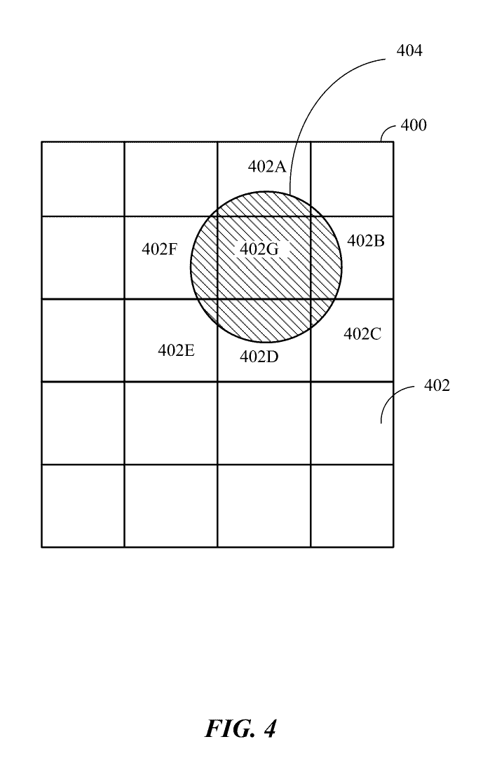

FIG. 4 illustrates an example of an environment to be mapped 400 according to aspects of the present disclosure. As shown in FIG. 4, a robot (not shown) may create a grid of the environment to be mapped 400. The grid forms multiple voxels 402. Furthermore, in this example, an object 404 is within the environment to be mapped 400. Thus, as shown in FIG. 4, some of the voxels 402 are empty, some of the voxels 402A-402F are partially occupied, and one voxel 402G is fully occupied.

As shown in FIGS. 3B, 3C, and 4, an environment to be mapped may be represented as a grid. Each cell in the grid may be referred to as a voxel. Furthermore, as previously discussed, each voxel has an occupancy level. The occupancy level may be referred to as the occupancy and/or the density. The occupancy level (d) may be a variable, such as a random variable, with a mean and a variance.

The mean of the occupancy level may be calculated from:

\hat{d}=E[d|z_{o:k}]

The variance of the occupancy level may be calculated from:

σ^{d}=Var[d|z_{o:k}]

The mean and variance are determined from all of the obtained measurements (z_{0:k}). In conventional systems, uncertainty is not specified for the measurements of voxels. For example, in conventional systems, if the reported occupancy level (e.g., cell posterior) is 0.5, a route planner may not determine if the 0.5 resulted from a few measurements or hundreds of measurements. Thus, the reliability of the occupancy level is unknown. Therefore, conventional systems may result in inconsistent maps due to inaccurate assumptions.

After determining an occupancy level, such as a mean occupancy level, of each voxel of multiple voxels, it is desirable to determine a confidence level (e.g., probability) of the determined occupancy level. For example, if multiple measurements have indicated that a voxel is occupied, there is a high probability that the voxel is occupied in comparison to a situation where only one measurement has indicated that a voxel is occupied. Furthermore, if an occupancy level of a voxel has a low confidence level (e.g., a confidence level below a threshold), the robot may move to various locations to take additional measurements to improve the confidence in the occupancy level.

In one configuration, an update rule is specified to determine the probability (p) of an occupancy level (d) for a voxel i of a map (m). The probability (p) may be referred to as a probability distribution function (PDF) that includes the mean, variance (e.g., confidence of the occupancy level.) In one configuration, the mean and variance may be extracted from the PDF of the occupancy level of a voxel. Furthermore, a route may be planned based on the mean and variance. The planning of the route and the extracting may be performed as described in U.S. provisional patent application No. 62/262,275 filed on Dec. 2, 2015, in the names of AGHAMOHAMMADI et al., the disclosure of which is expressly incorporated by reference herein in its entirety.

The probability may be determined based on EQUATION 1. In one configuration, the probability is approximated using lower order functions.

p(dⁱ|z_{0:k},xv_{0:k})=η′[(1−rₖ)hₖdⁱ+rₖ]p(θⁱ|z_{0:k-1},xv_{0:k-1}) (1)

In EQUATION 1, z_{0:k} are the measurements that have been collected by the sensor from time-step 0 to time-step k, and xv_{0:k} are the locations that have been measured by the sensor from time-step 0 to time-step k. Specifically, x is the center of a camera and v is a pixel location, such that xv defines a direction of a measurement ray from a sensor. That is, EQUATION 1 determines the probability of the occupancy level of a voxel i (dⁱ) given the obtained measurements (z_{0:k}) that are indexed by the visited locations (xv_{0:k}). The measurements (z_{0:k}) refer to the images/measurements received via sensors.

As shown in EQUATION 1, the probability (p) of an occupancy level at a voxel i (dⁱ) of a map (m) is based on a probability of the occupancy level of the voxel i (dⁱ) from a previous time-step p(dⁱ|z_{0:k-1},xv_{0:k-1}). Thus, it is desirable to calculate the term η′[(1−rₖ)hₖdⁱ+rₖ] to incrementally update the map. That is, if η′[(1−rₖ)hₖdⁱ+rₖ] is calculated, the probability of an occupancy level of a voxel i (dⁱ) at time-step k (e.g., p(dⁱ|z_{0:k},xv_{0:k})) may be calculated based on the probability of the occupancy level of a voxel i at a previous time-step k−1 (p(dⁱ|z_{0:k-1},xv_{0:k-1})). Specifically, by calculating η′[(1−rₖ)hₖdⁱ+rₖ], an incremental Bayesian update may be performed on the previously determined probability of an occupancy level of each voxel of multiple voxels to generate a map. Furthermore, the incremental Bayesian updates may be performed recursively calculating polynomial coefficients associated with the probability of the occupancy level of each voxel (e.g., p(dⁱ|z_{0:k-1},xv_{0:k-1})).

When determining an occupancy level for a voxel, it is desirable to determine which measurements contributed to determining the occupancy level for the voxel. That is, the occupancy level for voxel i (dⁱ) is based on data history (Hₖ={z_{0:k}, xv_{0:k}}). Aspects of the present disclosure consider a subset of the data history that includes direct information for the i-th voxel. In one configuration, the sensor maintains a history (H′) of the data z_{0:k}, xv_{0:k} that contributed to determining the occupancy level for a voxel i:

Hⁱ={z_{0:k},xv_{0:k}|voxelⁱεSensorCone(zₖ,xvₖ)} (2)

In EQUATION 2, Hⁱ includes the data z_{0:k}, xv_{0:k} that contributed to a measurement of voxel i based on whether voxel i fell into a sensor cone for a measurement at a time-step k (zₖ,xvₖ).

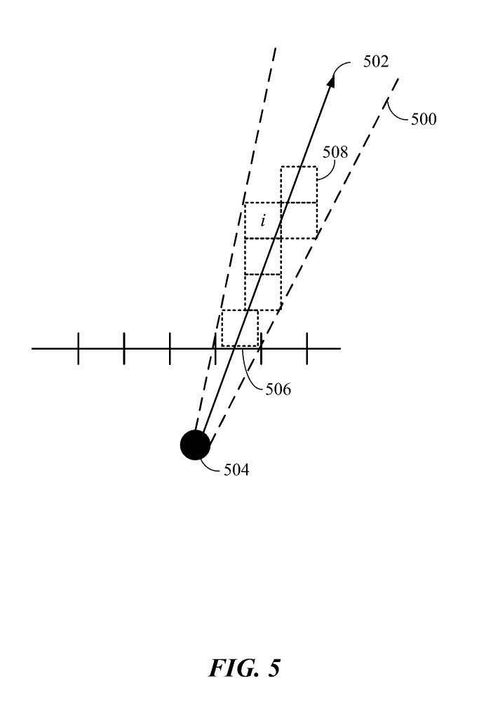

FIG. 5 illustrates an example of a measurement cone 500 according to an aspect of the present disclosure. As shown in FIG. 5, a measurement ray 502 is generated from a center of a camera (x) 504 and sent through a pixel location (v) 506. Furthermore, as shown in FIG. 5, multiple voxels 508 may fall within the measurement cone 500 of the measurement ray 502. Thus, for the current time-step k, for each voxel, such as voxel i, that falls within the measurement cone, the data (z_{0:k}, xv_{0:k}) is added to the history (Hⁱ) for the measurements that contributed to determining the occupancy level for voxel i. The data from the latest measurements and location may be used for an incremental Bayesian update.

For a measurement at a time-step, the sensor determines which voxels fall within the cone of the measurement and updates the probability of the occupancy level for the voxels that fall within the measurement cone. One measurement may be performed at each time-step. That is, EQUATION 1 is updated for each voxel of the multiple voxels when each voxel is within the measurement cone of a new measurement ray. In one configuration, when a new measurement is performed, hₖ and rₖ are calculated for the new measurement and the probability from a previous time-step p(dⁱ|z_{0:k-1},xv_{0:k-1}) is updated according to η′[(1−rₖ)hₖdⁱ+rₖ] to determine the probability for a current time-step p(dⁱ|z_{0:k},xv_{0:k}). Each measurement (z) is associated with a measurement ray indexed by a location (xv). Thus, hₖ is the probability of the measurement ray reaching voxel i (e.g., ray reachability probability). The variable hₖ may be defined as follows:

hₖ=h(xvₖ,mₖ₋₁), ∀k=1, . . . ,Y (3)

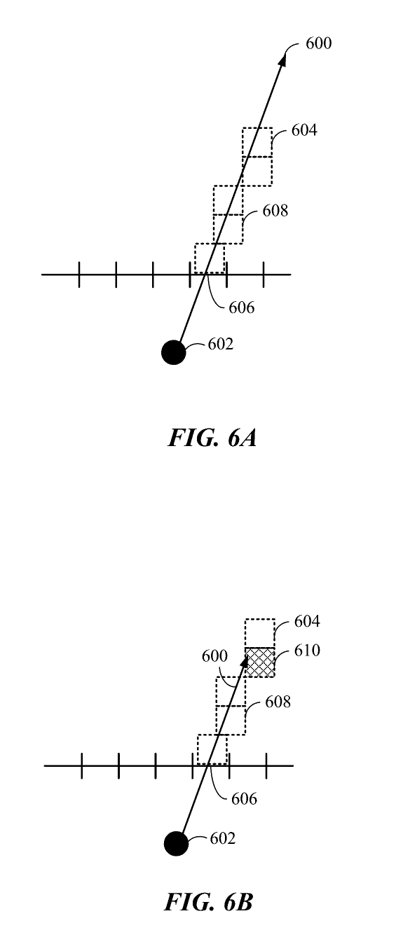

FIGS. 6A and 6B illustrate examples of measurement rays 600 according to aspects of the present disclosure. As shown in FIG. 6A, a measurement ray 600 may be transmitted from a sensor 602 through a pixel 606 in a direction (e.g., xv) towards a first voxel 604. In this example, the measurement ray passes through multiple voxels 608 and there are no objects between the sensor 602 and the first voxel 604. Thus, hₖ may indicate a high probability (e.g., a probability of one) that the measurement ray 600 will reach the first voxel 604.

As shown in FIG. 6B, a measurement ray 600 may be transmitted from a sensor 602 through a pixel 606 in a direction (e.g., xv) towards a first voxel 604. In this example, there is an object in a second voxel 610 of the multiple voxels 608 such that the object fully occupies the second voxel 610 that is between the sensor 602 and the first voxel 604. Thus, hₖ may indicate a low probability (e.g., a probability of zero) that the measurement ray 600 will reach the first voxel 604.

Furthermore, rₖ is a ratio based on a likelihood of obtaining a measurement (z) when the measurement ray has been intercepted (e.g., measurement likelihood given the map and excluding the cause) by the likelihood of obtaining a measurement (z) when the ray has been reflected (e.g., measurement likelihood given the cause). The variable rₖ may be defined as:

$${r}_{k} = \frac{p ( {z}_{k} \vert {m}_{k - 1} , {xv}_{k} , {xv}_{k} ∈ {\overline{S}}^{i} )}{p ( {z}_{k} \vert {xv}_{k} , {xv}_{k} ∈ {S}^{i} )} \qquad ( 4 )$$

In EQUATION 4, p(zₖ|xvₖ,xvₖSⁱ) defines the probability of obtaining a measurement at time-step k (zₖ) of a voxel i at a location (xvₖ) when the measurement ray has reflected (e.g., bounced back) from voxel i (xvₖ E Sⁱ). That is, p(zₖ|xvₖ,xvₖεSⁱ) defines the probability of voxel i being the cause of the measurement ray bouncing back. Furthermore, p(zₖ|mₖ₋₁,xvₖ,xvₖεS̅ⁱ) defines the probability of obtaining a measurement at time-step k (zₖ) of a voxel i at a location (xvₖ) when the measurement ray has not been reflected (e.g., bounced back) from voxel i but has been reflected from another voxel (xvₖεS̅ⁱ). That is rₖ is the ratio of a negative likelihood (e.g., obtaining a measurement of voxel i when voxel i was not the cause of the measurement ray bouncing back) to a positive likelihood (e.g., obtaining a measurement of voxel i when voxel i was the cause of the measurement ray bouncing back)

According to aspects of the present disclosure, for each measurement, the system determines the voxels that fall within a measurement cone. Furthermore, rₖ and hₖ may be computed for each of the voxels that fall within the measurement cone. Finally, the probability (e.g., PDF) of a voxel i is determined from EQUATION 1 using the probability of the previous time-step and the computed rₖ and hₖ. As an example, a voxel may have a first PDF at a first time step, then the PDF is updated based on measurements performed at a second time step to generate a second PDF, and the second PDF is updated again based on measurements performed at a third time step to generate a third PDF. A map may be generated at each time step, such that the map is incrementally updated based on the updated PDFs of the voxels of the map.

As previously discussed, by computing rₖ and hₖ for each voxel that is within a measurement cone of a measurement, an incremental Bayesian update may be performed on the probability of an occupancy level of each of the voxels that is within the measurement cone. In one configuration, the Bayesian updates are based on a stochastic map and/or a probabilistic sensor model as described in U.S. provisional patent application No. 62/262,339 filed on Dec. 2, 2015, in the names of AGHAMOHAMMADI et al., the disclosure of which is expressly incorporated by reference herein in its entirety. The sensor model accounts for stochastic maps and sensor variability.

In another configuration, the incremental Bayesian updates may be parallelized over voxels. For example, if multiple voxels are in a measurement cone at time-step k, the incremental Bayesian update for each voxel may be processed by a different processing element, such that the parallelizing of the incremental Bayesian updates is performed over voxels. That is, each processing element processes an incremental Bayesian update to parallelize the incremental Bayesian updates over voxels.

Aspects of the present disclosure have described a sensor, such as a stereo vision sensor, for performing measurements. Of course, aspects of the present disclosure are not limited to a stereo vision sensor as other types of sensors, such as, for example, radar, thermal, sonar, and/or lasers are also contemplated for performing measurements.

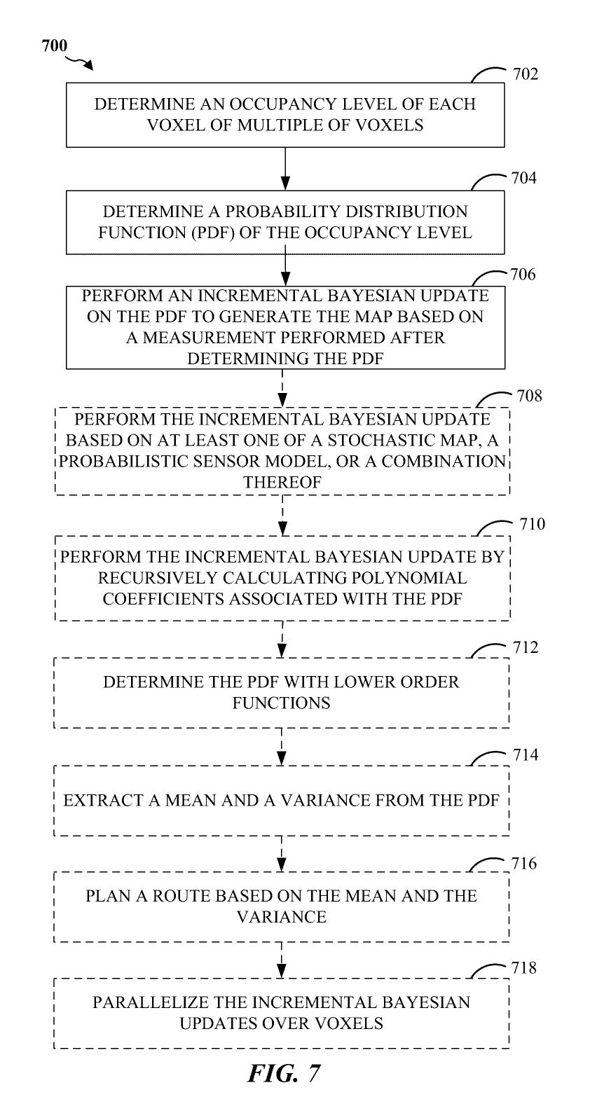

FIG. 7 illustrates a method 700 for generating a map. In block 702, the system determines an occupancy level of each voxel of multiple voxels. In some aspects, the occupancy level is determined based on a mean occupancy level. Furthermore, in block 704, the system determines a PDF of the occupancy level. Finally, in block 706, the system performs an incremental Bayesian update on the PDF to generate the map based on a measurement performed after determining the PDF.

In some aspects, the robot may optionally perform the incremental Bayesian update based on at least one of a stochastic map, a probabilistic sensor model, or a combination thereof, in block 708. Alternatively, the robot may optionally perform the incremental Bayesian update by recursively calculating polynomial coefficients associated with the PDF, in block 710. In some aspects, the robot may optionally determine the PDF with lower order functions, in block 712. In some aspects, the robot may optionally extract a mean and a variance from the PDF, in block 714. In some aspects, the robot may optionally plan a route based on the mean and the variance, in block 716. In some aspects, the robot may optionally parallelize the incremental Bayesian updates over voxels, in block 718.

In some aspects, method 700 may be performed by the SOC 100 (FIG. 1) or the system 200 (FIG. 2). That is, each of the elements of method 700 may, for example, but without limitation, be performed by the SOC 100 or the system 200 or one or more processors (e.g., CPU 102 and local processing unit 202) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for generating a map, comprising:
determining an occupancy level of each voxel of a plurality of voxels;
determining a probability distribution function (PDF) of the occupancy level of each voxel of the plurality of voxels; and
performing an incremental Bayesian update on the PDF to generate the map based on a measurement performed after determining the PDF.

2. The method of claim 1, further comprising performing the incremental Bayesian update based on at least one of a stochastic map, a probabilistic sensor model, or a combination thereof.

3. The method of claim 1, further comprising performing the incremental Bayesian update by recursively calculating polynomial coefficients associated with the PDF.

4. The method of claim 1, further comprising determining the PDF with lower order functions.

5. The method of claim 1, further comprising extracting a mean and a variance from the PDF.

6. The method of claim 5, further comprising planning a route based on the mean and the variance.

7. The method of claim 1, further comprising parallelizing the incremental Bayesian updates over voxels.

8. The method of claim 1, further comprising determining a mean occupancy level to determine the occupancy level.

9. An apparatus for generating a map, comprising:
a memory; and
at least one processor coupled to the memory, the at least one processor configured:
to determine an occupancy level of each voxel of a plurality of voxels;
to determine a probability distribution function (PDF) of the occupancy level of each voxel of the plurality of voxels; and
to perform an incremental Bayesian update on the PDF to generate the map based on a measurement performed after determining the PDF.

10. The apparatus of claim 9, in which the at least one processor is further configured to perform the incremental Bayesian update based on at least one of a stochastic map, a probabilistic sensor model, or a combination thereof.

11. The apparatus of claim 9, in which the at least one processor is further configured to perform the incremental Bayesian update by recursively calculating polynomial coefficients associated with the PDF.

12. The apparatus of claim 9, in which the at least one processor is further configured to determine the PDF with lower order functions.

13. The apparatus of claim 9, in which the at least one processor is further configured to extract a mean and a variance from the PDF.

14. The apparatus of claim 13, in which the at least one processor is further configured to plan a route based on the mean and the variance.

15. The apparatus of claim 9, in which the at least one processor is further configured to parallelize the incremental Bayesian updates over voxels.

16. The apparatus of claim 9, in which the at least one processor is further configured to determine a mean occupancy level to determine the occupancy level.

17. An apparatus for generating a map, comprising:
means for determining an occupancy level of each voxel of a plurality of voxels;
means for determining a probability distribution function (PDF) of the occupancy level of each voxel of the plurality of voxels; and
means for performing an incremental Bayesian update on the PDF to generate the map based on a measurement performed after determining the PDF.

18. The apparatus of claim 17, further comprising means for performing the incremental Bayesian update based on at least one of a stochastic map, a probabilistic sensor model, or a combination thereof.

19. The apparatus of claim 17, further comprising means for performing the incremental Bayesian update by recursively calculating polynomial coefficients associated with the PDF.

20. The apparatus of claim 17, further comprising means for determining the PDF with lower order functions.

21. The apparatus of claim 17, further comprising means for extracting a mean and a variance from the PDF.

22. The apparatus of claim 21, further comprising means for planning a route based on the mean and the variance.

23. The apparatus of claim 17, further comprising means for parallelizing the incremental Bayesian updates over voxels.

24. The apparatus of claim 17, further comprising means for determining a mean occupancy level to determine the occupancy level.

25. A non-transitory computer-readable medium having program code recorded thereon for generating a map, the program code being executed by a processor and comprising:
program code to determine an occupancy level of each voxel of a plurality of voxels;
program code to determine a probability distribution function (PDF) of the occupancy level of each voxel of the plurality of voxels; and
program code to perform an incremental Bayesian update on the PDF to generate the map based on a measurement performed after determining the PDF.

26. The non-transitory computer-readable medium of claim 25, further comprising program code to perform the incremental Bayesian update based on at least one of a stochastic map, a probabilistic sensor model, or a combination thereof.

27. The non-transitory computer-readable medium of claim 25, further comprising program code to perform the incremental Bayesian update by recursively calculating polynomial coefficients associated with the PDF.

28. The non-transitory computer-readable medium of claim 25, further comprising program code to determine the PDF with lower order functions.

29. The non-transitory computer-readable medium of claim 25, further comprising program code to extract a mean and a variance from the PDF.

30. The non-transitory computer-readable medium of claim 29, further comprising program code to plan a route based on the mean and the variance.

31. The non-transitory computer-readable medium of claim 25, further comprising program code configured to parallelize the incremental Bayesian updates over voxels.

32. The non-transitory computer-readable medium of claim 25, further comprising program code to determine a mean occupancy level to determine the occupancy level.
